(19) United States
(12) Patent Application Publication
(10) Pub. No.: US 2015/0329350 A1
(43) Pub. Date: Nov. 19, 2015

(54) A STIRRUP IRON

(71) Applicant: HORSEWARE PRODUCTS LTD, County Louth, Dundalk (IE)

(72) Inventor: Christopher BOWE, Grantstown (IE)

(73) Assignee: HORSEWARE PRODUCTS LTD, Dundalk (IE)

(21) Appl. No.: 14/651,523

(22) PCT Filed: Dec. 9, 2013
(86) PCT No.: PCT/EP2013/075990

§ 371 Date: Jun. 11, 2015

(30) Foreign Application Priority Data
Dec. 12, 2012 (GB) 1222389.7
Aug. 14, 2013 (GB) 1314572.7

(51) Int. Cl. B68C 3/02

(52) U.S. Cl. CPC B68C 3/02

(57) ABSTRACT

This invention relates to a stirrup iron (1) comprising a two part construction including a first, fixed part (3), and a second, moveable part (5). The fixed part (3) comprises a body and the moveable part (5) comprises an L-shaped arm pivotally mounted to the fixed part (3).The moveable part (5) is pivotable to and from a first operating position in which a step portion (15) of the moveable part (5) forms a closed loop stirrup, and a second operating position in which the step portion (15) is located below and spaced apart from the fixed part (3) thereby forming a foot-step. The stirrup iron (1) further comprises a releasable locking mechanism, a foot plate (19) mounted on the fixed part (3) and a cam mechanism connecting the foot plate (19) to the moveable part (5). Depression of the foot plate (19) will cause the cam mechanism to act on the moveable part (5) urging it from the second operating position towards the first operating position.

### TECHNICAL FIELD

This invention relates to a stirrup iron for assisting a rider mounting a horse (or other equine).

### BACKGROUND ART

A pair of stirrups is typically provided on a saddle to assist a rider in mounting a horse and to help maintain their balance while riding the horse. Stirrups usually comprise a stirrup iron, where a rider places their foot, connected to the saddle by an adjustable strap known as a stirrup leather. The length of the stirrups can be adjusted to suit the length of the rider's legs or the riding activity by either shortening or lengthening the stirrup leather.

Traditionally, a rider will mount a horse from the left side, or near side, of the animal by elevating their left foot, inserting it into the left stirrup iron and then lifting themselves onto the saddle by placing their weight onto their left foot. However, when the stirrups are at a suitable length for riding, many riders experience difficulty in elevating their foot to the height of the stirrup iron in order to mount the horse. Depending on the height of the horse or the rider, it may prove difficult to mount the horse while the stirrups are at a shortened riding length. For example, it is common to ride with stirrups at a shorter length for activities such as jumping or galloping. Furthermore, the riding length of the stirrups will also depend in part on the height of the rider and their leg length.

Such difficulties in mounting a horse are usually overcome by the rider standing on an object such as a mounting block placed beside the horse to assist them in reaching the stirrup iron. Alternatively, the horse may be positioned beside a wall or a fence which the rider stands upon to assist them in mounting the horse. However, standing on an object to mount a horse is not safe as the horse can move away from the object unexpectedly. Additionally, in many instances, such as where a horse is nervous or excited, it can prove difficult to keep the horse standing beside an object to allow a rider to mount safely. Furthermore, such objects may not always be available when out riding.

A second person may provide assistance from the ground by boosting the rider or giving them a ‘leg up’. However, a second person may not always be present to assist the rider in mounting, for example in situations where the rider is out hunting or hacking. While out riding, it is often necessary to dismount and mount the horse on several occasions, for example to open or close gates, lead a nervous horse or pick up a dropped riding crop.

Many riders will lengthen their stirrup prior to mounting a horse to assist them in reaching the stirrup iron with their foot. However, once the rider has mounted it can prove difficult to adjust the stirrup to the correct riding length while astride the horse. Furthermore, inexperienced riders may have difficulty in maintaining control of their horse while holding the reins in one hand and adjusting the stirrup length with their other hand. Additionally, in some instances the stirrup leather may not allow sufficient lengthening to assist mounting. Generally speaking, adjustment of the stirrup leather while mounted on a horse is difficult, time consuming and undesirable to do.

There are a number of known mounting aids for attachment to a saddle or stirrup to assist a rider in mounting a horse. One such mounting aid is that described in U.S. Pat. No. 6,282,872. This patent discloses a mounting step stirrup which also functions as a breakaway safety stirrup. However, this has the disadvantage that the stirrup may open while riding if the rider inadvertently places too much pressure from their foot against the outside of the stirrup. Furthermore, the stirrup may open if snagged on a low branch or fence rail. Additionally, the spring mechanism to allow pivoting of the mounting step may lose resilience over time or become rusted or clogged with dirt thereby preventing correct operation.

Another mounting aid is described in U.S. Pat. No. 5,809,754. This patent describes a pivotable step for a stirrup which pivots to a position below the stirrup to assist a rider in mounting a horse. However, as this device pivots upwards to a closed position once the rider has mounted, it is liable to brush off the body of the horse which may startle or pinch the animal. Furthermore, the horse may incorrectly interpret this as a signal from the rider to move forwards.

U.S. Pat. No. 4,761,938 describes a stirrup extension which attaches to a conventional stirrup. However, once the rider has mounted it is necessary to remove the stirrup extension. Although such a device will initially assist the rider in mounting, they may experience difficultly should they have to dismount and remount as it is not practical to carry such a device while riding.

It is an object of the present invention to provide a mounting aid that overcomes at least some of the above-identified problems.

### DISCLOSURE OF INVENTION

According to the invention there is provided a stirrup iron comprising a two part construction including a first, fixed part, and a second, moveable part, moveable relative to the fixed part;
the fixed part comprising a body having a base plate, a side upright connected at one end of the base plate and extending upwardly therefrom, and a top plate connected at one of its ends to the side upright and extending outwardly therefrom above and spaced apart from the base plate;
the moveable part comprising a substantially L-shaped arm having a connector portion pivotally mounted to the fixed part at one end thereof, and a step portion extending substantially orthogonal to the connector portion, the moveable part being pivotable to and from a first operating position in which the connector portion lies adjacent to and substantially in-line with the base plate and the step portion extends upwardly from the free end of the base plate to the free end of the top portion thereby forming a closed loop stirrup, and a second operating position in which the connector portion extends downwardly from and substantially orthogonal to the base plate and the step portion extends outwardly from the connector portion below and spaced apart from the base plate thereby forming a foot-step;

and in which the stirrup iron comprises:
a releasable locking mechanism operable to maintain the moveable part in the first operating position;
a foot plate mounted on the fixed part; and
a cam mechanism connecting the foot plate to the moveable part so that depression of the foot plate will cause the cam mechanism to act on the moveable part urging it from the second operating position towards the first operating position.

By having such a stirrup iron, the stirrup iron will provide a step to facilitate mounting of the horse. The step is integral with the remainder of the stirrup iron and a separate piece of kit is not required. Once the rider's foot is placed on the foot plate, the stirrup iron will automatically assume a closed loop configuration. The rider will not have to adjust buckles, straps or other devices and they will at no stage have to take their hands off the reins in order to close the stirrup iron. Furthermore, the configuration of stirrup iron will not have a tendency to pinch or otherwise harm or startle the animal as it assumes the closed loop configuration. Advantageously, the stirrup iron will not have a tendency to inadvertently open during use as the weight of the rider acts to close the stirrup iron. In addition to the above, the performance of the stirrup iron will not be affected to the same degree by the ingress of dirt and will not have the same tendency to degrade over time as the components age.

In one embodiment of the invention there is provided a stirrup iron in which the cam mechanism comprises a single connector link arm mounted at one end to the foot plate and pivotally mounted at its other end to the connector arm. This is seen as a simple construction of device that will be relatively inexpensive to manufacture and reliable in operation.

In one embodiment of the invention there is provided a stirrup iron in which the cam mechanism comprises a pair of spaced-apart connector link arms mounted at one end to the foot plate and pivotally mounted at the other end to the connector arm. This configuration is seen as a useful alternative to the single connector arm embodiment.

In one embodiment of the invention there is provided a stirrup iron in which the foot plate is provided with a non-slip cover.

In one embodiment of the invention there is provided a stirrup iron in which the non-slip cover is releasably detachable from the foot plate.

In one embodiment of the invention there is provided a stirrup iron in which one side of the step portion that is intended for engagement of a riders boot is provided with a non-slip surface. This is seen as particularly useful as the surface on which the rider's boot will be located will provide grip to the rider's boot assisting in their mounting of the horse and obviating the possibility of the rider slipping.

In one embodiment of the invention there is provided a stirrup iron in which the non-slip surface is provided by way of a serrated surface. This is seen as a simple inexpensive way of providing grip that can be incorporated into the moulding or casting of the stirrup iron.

In one embodiment of the invention there is provided a stirrup iron in which the releasable locking mechanism is provided with a catch mechanism which is spring loaded into a locking configuration.

In one embodiment of the invention there is provided a stirrup iron in which the catch mechanism is provided with a release button that is recessed into the two part construction to avoid inadvertent release of the releasable locking mechanism. By having a release latch recessed into the two part construction, there will be far less tendency for the stirrup iron to be opened inadvertently.

In one embodiment of the invention there is provided a stirrup iron in which the free end of the top plate and the free end of the step portion are both dimensioned for complementary mating with the other of the free end of the step portion and the free end of the top plate.

In one embodiment of the invention there is provided a stirrup iron in which the top plate is provided with an aperture for reception of a stirrup leather.

### BRIEF DESCRIPTION OF DRAWINGS

The invention will now be more clearly understood from the following description of some embodiments thereof given by way of example only with reference to the accompanying drawings, in which:

FIG. 1 is a front perspective view of a stirrup iron according to the invention;

FIG. 2 is a rear perspective view of the stirrup iron according to the invention;

FIG. 3 is a front view of the stirrup iron with the moveable part in the first operating position;

FIG. 4 is a front view of the stirrup iron with the moveable part in the second operating position;

FIG. 5 is a side view of the stirrup iron shown in FIG. 4;

FIG. 6 is a cross-sectional view along the lines A-A of the stirrup iron shown in FIG. 5;

FIG. 7 is a cross-sectional view along the lines B-B of the stirrup iron shown in FIG. 5;

FIG. 8 is a side view of the stirrup iron shown in FIG. 3;

FIG. 9 is a cross-sectional view along the lines C-C of the stirrup iron shown in FIG. 8;

FIG. 10 is a cross-sectional view along the lines D-D of the stirrup iron shown in FIG. 8;

FIG. 11 is a front perspective view of the stirrup iron intermediate the first and second operating positions;

FIG. 12 is a front view of the stirrup iron shown in FIG. 11;

FIG. 13 is a rear perspective view of the stirrup iron shown in FIG. 11;

FIG. 14 is a side view of the stirrup iron shown in FIG. 12;

FIG. 15 is a cross-sectional view along the lines E-E of the stirrup iron shown in FIG. 14;

FIG. 16 is a cross-sectional view along the lines F-F of the stirrup iron shown in FIG. 14;

FIG. 17 is a rear perspective view of an alternative embodiment of stirrup iron according to the invention in the first operating position;

FIG. 18 is a side view of the stirrup iron shown in FIG. 17 in the second operating position;

FIG. 19 is a cross-sectional view along the lines G-G of the stirrup iron shown in FIG. 18;

FIG. 20 is a cross-sectional perspective view along the lines H-H of the stirrup iron shown in FIG. 18;

FIG. 21 is a front perspective view of a further alternative embodiment of stirrup iron according to the invention with the moveable part in the first operating position;

FIG. 22 is a front perspective view of the stirrup iron of FIG. 21 with the moveable part in the second operating position;

FIG. 23 is a front view of the stirrup iron shown in FIG. 22;

FIG. 24 is a side view of the stirrup iron shown in FIG. 22;

FIG. 25 is a cross-sectional view along the lines J-J of the stirrup iron shown in FIG. 24;

FIG. 26 is a front view of a further still alternative embodiment of stirrup iron according to the invention with the moveable part in the first operating position;

FIG. 27 is a front perspective view from below of the stirrup iron of FIG. 26 with the moveable part in the second operating position;

FIG. 28 is a front view of the stirrup iron of FIG. 26 with the moveable part intermediate the first and second operating positions; and

FIG. 29 is an enlarged view of the portion encircled by the circle K in FIG. 28.

### MODES OF CARRYING OUT THE INVENTION

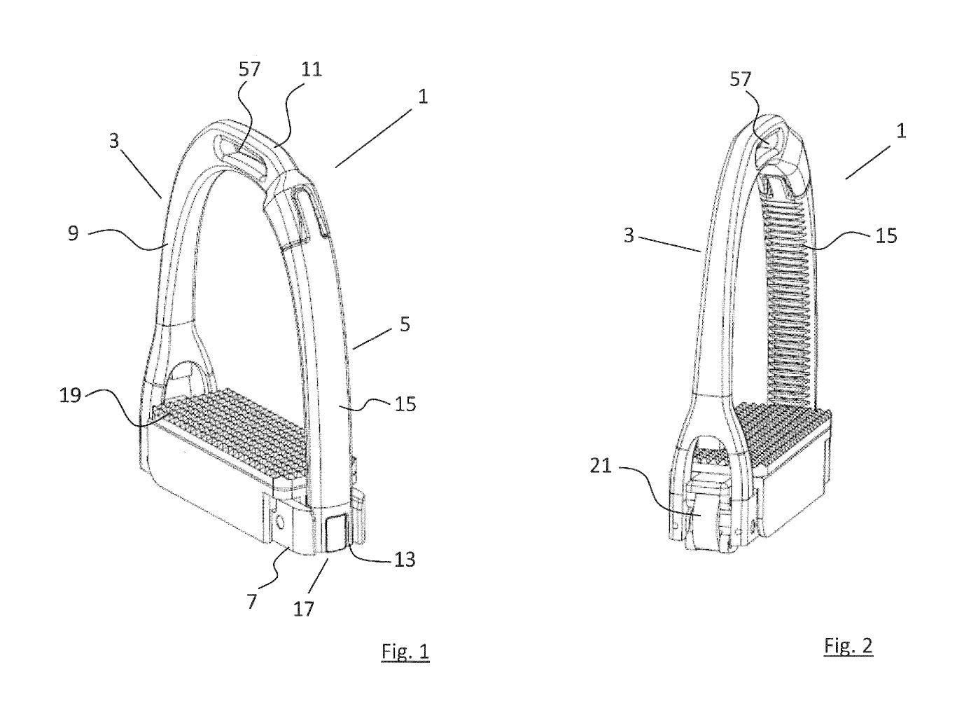

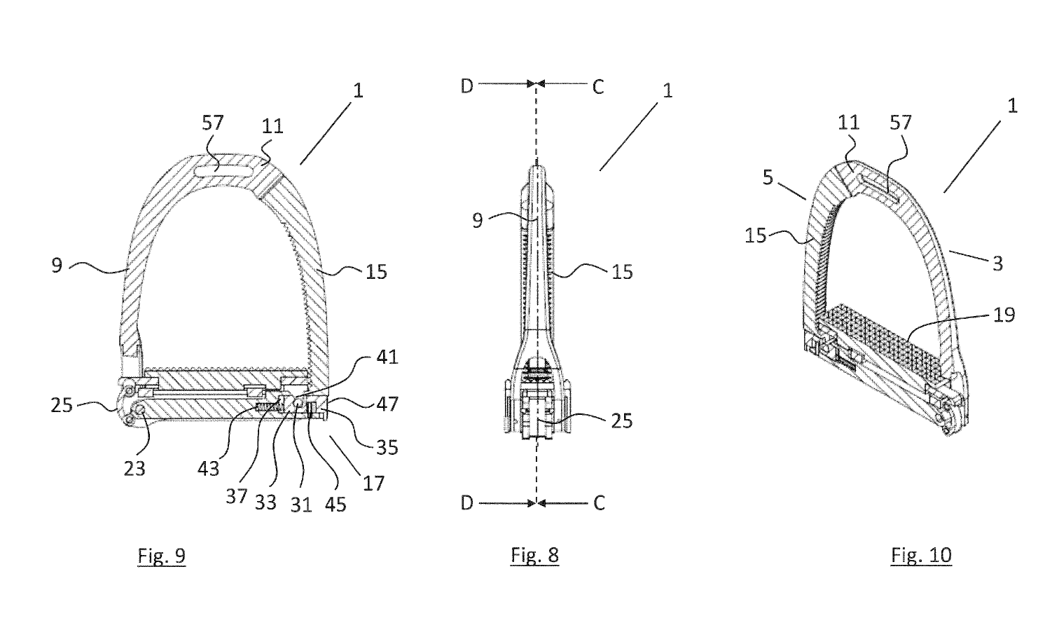

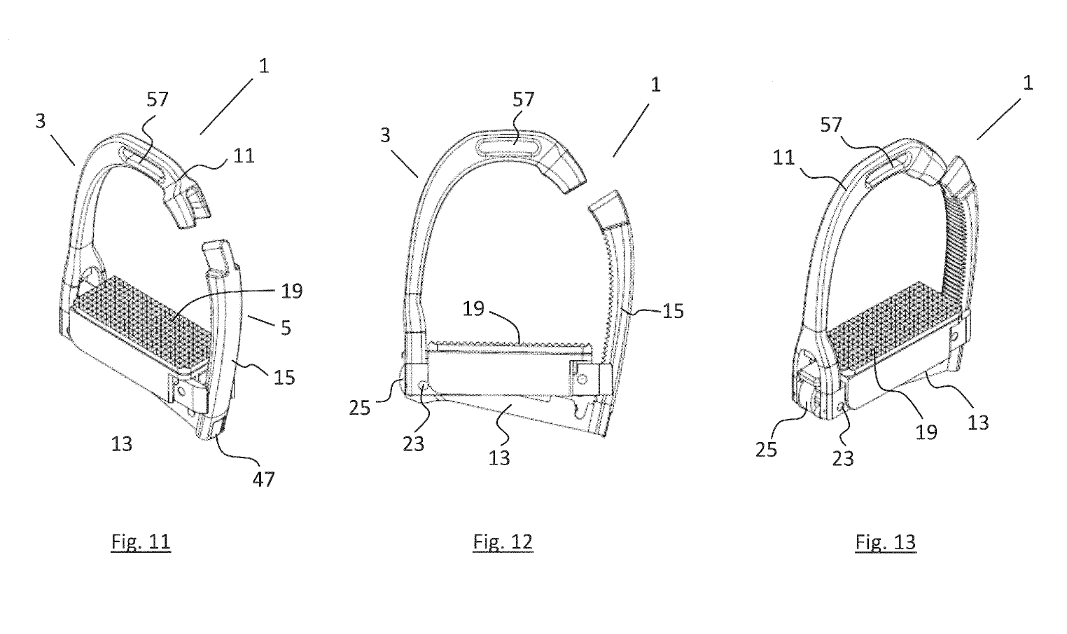

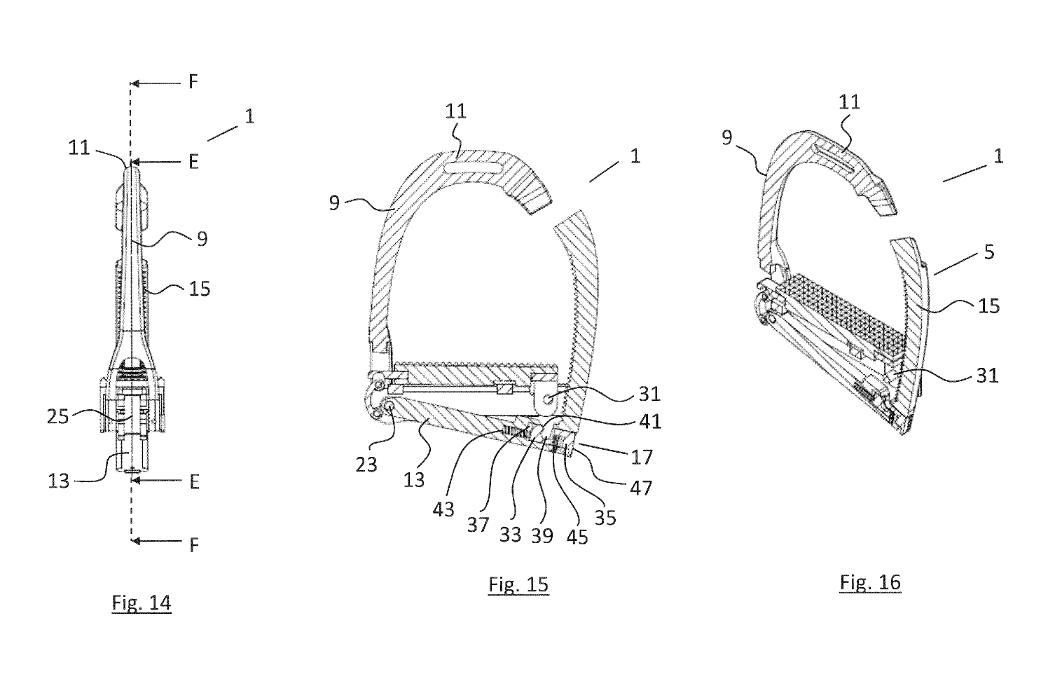

Referring to FIGS. 1 to 16 inclusive, there is shown a stirrup iron, indicated generally by the reference numeral 1, comprising a two part construction including a first, fixed part 3, and a second, moveable part 5 that is moveable relative to the fixed part 3. In the embodiment shown, the first fixed part 3 comprises a substantially C-shaped body having a base plate 7, a side upright 9 and a top plate 11. The side upright 9 is connected to the base plate adjacent one, innermost end thereof and the top plate is connected at one of its ends to the uppermost end of the side upright. The top plate 11 extends outwardly from the side upright 9 above and spaced apart from the base plate 7. The moveable part 5 comprises a substantially L-shaped arm having a connector portion 13 pivotally mounted to the fixed part 3 at one end thereof, and a step portion 15 extending substantially orthogonal to the connector portion 13. The stirrup iron 1 further comprises a releasable locking mechanism 17, a foot plate 19 mounted on the fixed part 3 and a cam mechanism 21 connecting the foot plate 19 to the moveable part 5.

The moveable part 5 is pivotable about pivot point 23 to and from a first operating position (as illustrated in FIGS. 1-3 inclusive) in which the connector portion 13 of the moveable part lies adjacent to and substantially in-line with the base plate 7 of the fixed part and the step portion 15 extends upwardly from the free end of the base plate 7 to the free end of the top portion thereby forming a closed loop stirrup, and a second operating position (as illustrated in FIG. 4) in which the connector portion 13 extends downwardly from and substantially orthogonal to the base plate 7 and the step portion 15 extends outwardly from the connector portion 13 below and spaced apart from the base plate 7, thereby forming a foot-step.

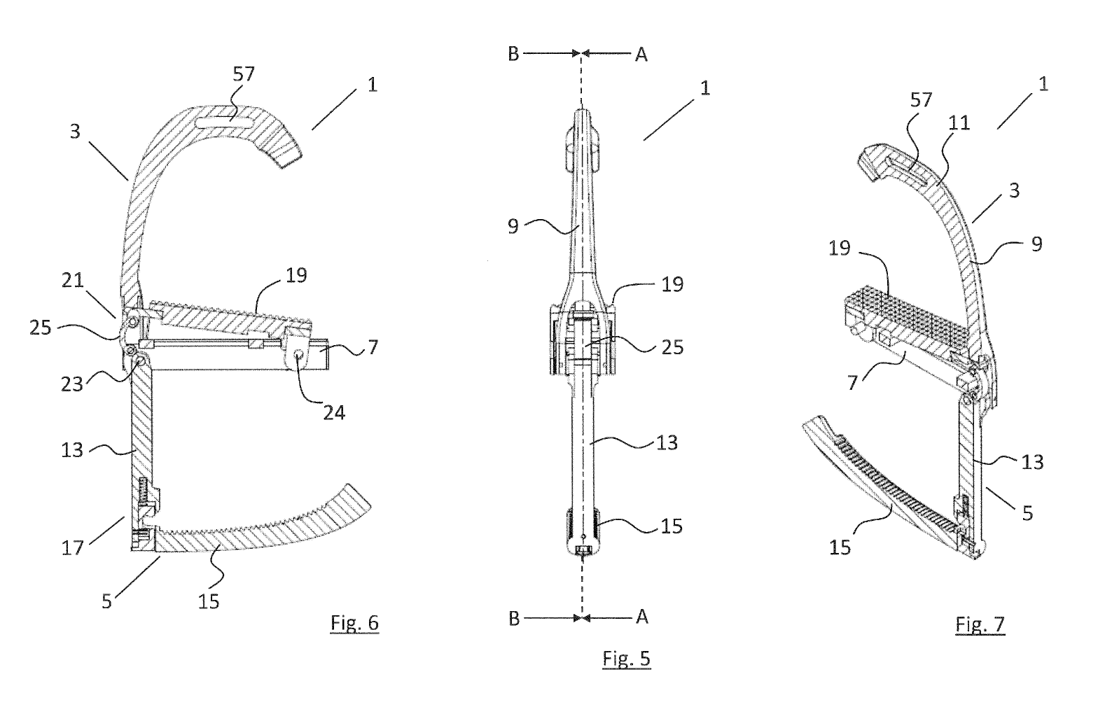

Referring specifically to FIGS. 5 to 10 inclusive, there are shown a plurality of views in which the foot plate 19 and cam mechanism 21 and the operation thereof are shown in greater detail. The foot plate 19 is pivotably mounted on the base plate 7 about pivot point 24. The cam mechanism comprises a link arm 25 mounted pivotably at one end to the foot plate 19 and pivotably mounted at its other end to the connector portion 13 of the moveable part 5. In use, when downward pressure is applied to the foot plate 19, the link arm 25 also moves downwardly, thereby causing the connector portion 13 to pivot about its pivot mounting point 23. As the connector portion 13 pivots about its pivot mounting point 23, it will move from the position shown in FIG. 6 to the position shown in FIG. 9. At the same time, the step portion 15 will pivot from the position shown in FIG. 6 to the position shown in FIG. 9. The releasable locking mechanism 17 holds the moveable part in a fixed relationship to the fixed part once the moveable part assumes the position shown in FIG. 9.

Conversely, if the releasable locking mechanism 17 is disengaged and there is no downward force applied to the foot plate, the connector portion 13 and the step portion 15 will be allowed to pivot about pivot point 23 in the opposite direction, namely from the configuration shown in FIG. 9 to the configuration shown in FIG. 6. The connector portion 13 and the step portion 15 will fall under gravity to the position shown in FIG. 6.

Referring now to FIGS. 9 and 15, the operation of the releasable locking mechanism 17 will be described in greater detail. The releasable locking mechanism comprises a locking bar 31 mounted on the fixed part 3 and complementary catch mechanism 33 mounted on the moveable part 5. The complementary catch mechanism is operable to engage the locking bar and maintain the fixed part and the moveable part in a fixed relationship with each other. The catch mechanism comprises a locking cylinder 35 slidably mounted for reciprocal movement in an internal blind bore 37 formed in the connector portion 13 of the moveable part 5. The locking cylinder 35 includes a recessed channel 39 formed therein for reception of the locking bar 31, and there is provided an inwardly depending jaw 41 at the mouth of the channel 39. A resiliently deformable biasing member, in this case provided by way of helical spring 43 is located at the bottom of the blind bore 37 and urges the locking cylinder 35 towards a locking configuration. A retaining member 45 is provided to engage the locking cylinder 35 to limit the degree of movement of the locking cylinder and prevent escape of the locking cylinder from the blind bore.

In use, when the helical spring is at rest, the locking cylinder is in the position shown in FIGS. 9 and 15. However, as the connector portion 13 is pivoted about the point 23, the locking cylinder 35 will be moved towards the locking bar 31. As the locking cylinder approaches the locking bar 31, the jaw 41 of the locking cylinder 35 will come into contact with the locking bar 31. The upper surface of the jaw is dimensioned so that as further force is applied, the locking bar 31 will act on the jaw 41 to move the locking cylinder 35 inwardly in the blind bore 37 in a direction towards the closed end of the blind bore against the force of the helical spring 43. As the jaw 41 passes by the locking bar 31, the helical spring 43 will cause the locking cylinder 35 to move in the opposite direction, namely in the direction of the open end of the blind bore. In this way, the locking bar 31 will be captured in the channel 39. The connector arm will be prevented from moving downwardly by virtue of the locking bar 31 engaging the underside of the jaw 41.

In order to release the locking mechanism 17 and allow the moveable part 5 transition from the first operating position shown in FIG. 9 to the second operating position shown in FIG. 6, there is provided a recessed release button 47 at the end of the locking cylinder 35. Depression of the release button will cause the locking cylinder 35 to move inwardly in the blind bore 37 thereby moving the jaw 41 from a position above the locking bar 31 to a position free of the locking bar thereby releasing the locking bar from the channel and allowing downward pivoting movement of the moveable part relative the fixed part from the configuration shown in FIG. 9 to the configuration shown in Figure 6. The helical spring 43 and the configuration of the channel 39 and jaw 41 in particular will be selected to ensure that the weight of the moveable part 5 is insufficient to allow inadvertent release of the releasable locking mechanism 17.

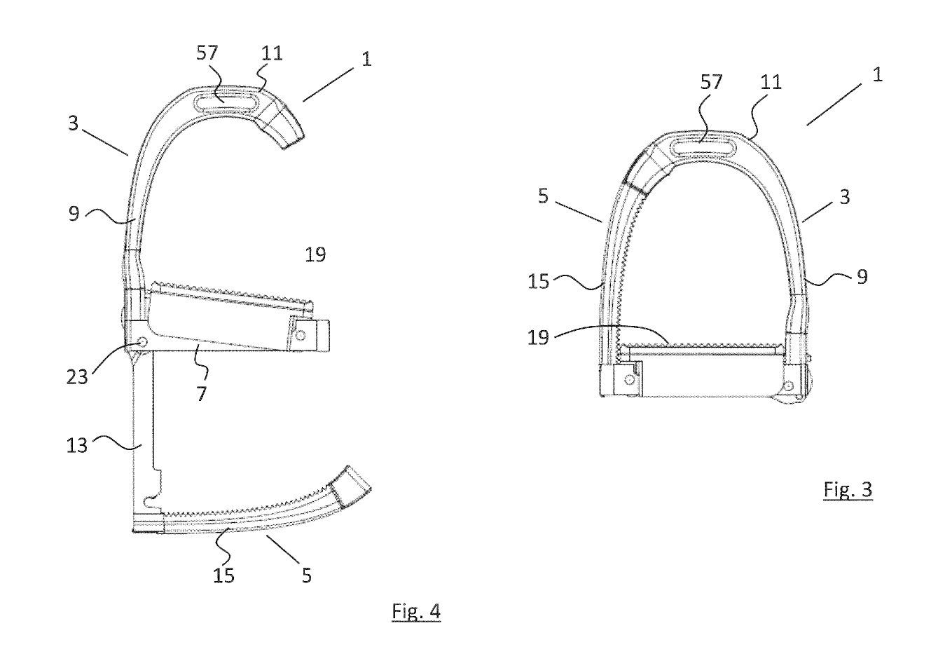

In use, before mounting a horse (not shown), a rider (not shown) will depress release button 47 to disengage the releasable locking mechanism 17. As they do so, the moveable part 5 will pivot downwardly relative the fixed part 3 about the pivot point 23, from the first operating position as shown in FIG. 3, to the second operating position shown in FIG. 4. As can be seen from the drawings and FIG. 4 in particular, when the moveable part 5 is in the second operating position, the step portion 15 will be located below and substantially parallel to the base plate 7 of the fixed part 3 and the foot plate 19. In the embodiment shown, the step portion 15 will be located approximately 150 mm below the base plate 7 and the foot plate 19, thereby providing a more accessible step for the foot of the rider. For the purposes of this example, the invention will be described in terms of the rider mounting the horse from the near side. The rider places their left foot onto the step portion 15 and throws their right leg over the horse. The rider thereafter will place their right foot into a second stirrup iron located on the off side of the horse. The second stirrup iron may be a standard stirrup iron or may be a stirrup iron such as that described in the present application already in a first operating position. Once the rider's right foot is in position in the off side stirrup iron, the rider will thereafter place their left foot onto the foot plate 19. As the rider places their weight onto their left foot, and by extension onto the foot plate 19, the foot plate 19 will pivot downwards about the pivot point 24. This in turn will act upon the cam mechanism 21 which will act upon the connector arm 13 causing the connector arm to pivot about the pivot point 23. The connector arm 13 and the rest of the moveable part 5 will pivot from the second operating position shown in FIG. 4 to the first operating position shown in FIG. 3.

Once the moveable part 5 is in the second operating position, the releasable locking mechanism 17 will maintain the moveable part and the fixed part in fixed relationship with each other in the configuration shown in FIG. 3. Furthermore, the downward pressure exerted on the foot plate 19 will act to urge the moveable part into the second operating position as shown in FIG. 3. It can be seen that throughout the mounting operation, the rider will not have to take their hands off the reins to adjust the stirrup iron and the stirrup iron will automatically close under the weight of their body as their foot is pressed downwardly on the foot plate 19. Furthermore, the stirrup iron will not require separate biasing means in order to assume the closed stirrup, first operating position and therefore will be reliable in use.

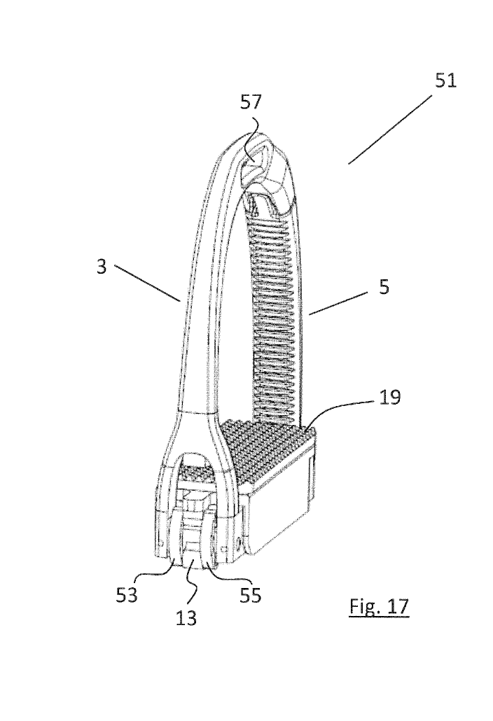

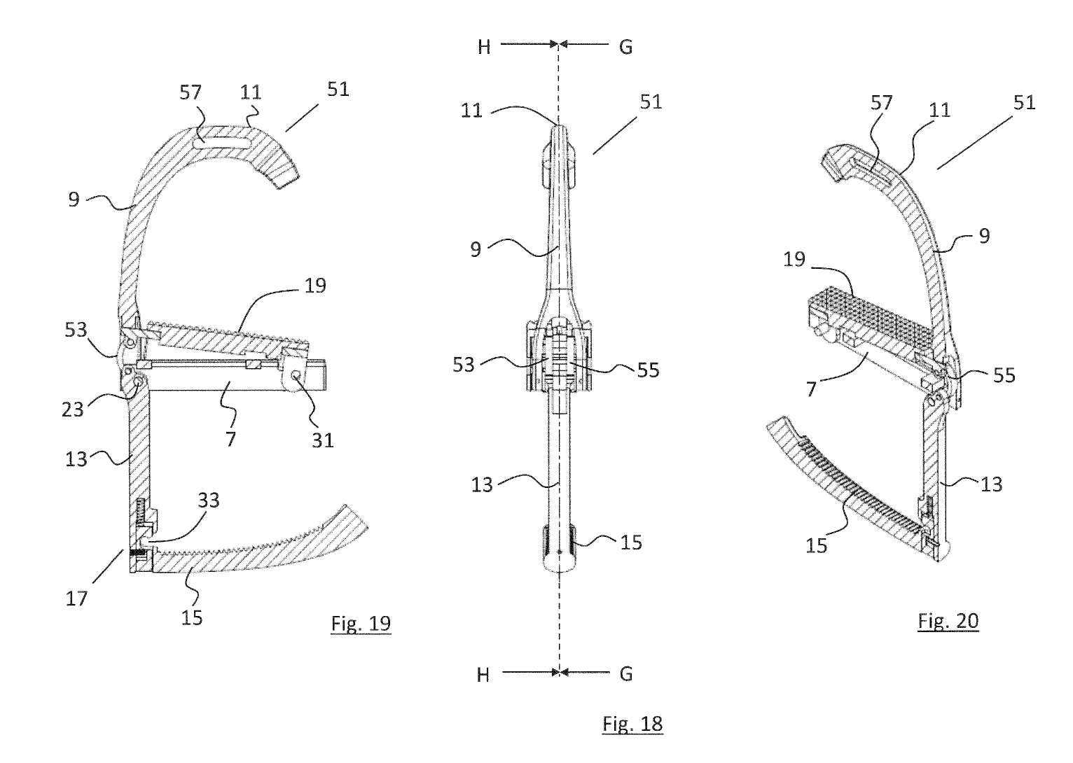

Referring to FIGS. 17 to 20, there is shown an alternative embodiment of a stirrup iron according to the present invention, in which like parts have been given the same reference numerals as before. The stirrup iron, indicated generally by the reference numeral 51 comprises a pair of cam linkage arms 53, 55 connecting the foot plate 19 to the connector portion 13. The operation of the stirrup iron 51 is identical to the embodiment described with reference to FIGS. 1 to 16 inclusive.

In addition to the foregoing, various modifications can be made to the stirrup iron to improve its functionality. For example, the foot plate 19 is preferably provided with a removable cover with a grip coating such as, but not limited to, rubber or appropriately configured plastic or metal with raised surfaces to provide improved grip to a rider's boot. Furthermore, the inside/upper surface of the step portion 15 of the moveable part is dimensioned to provide grip to the rider. This is achieved by having a serrated surface that will provide improved grip to the rider's boot as they are mounting the horse. As an alternative to the serrated edge, a suitable covering could be provided on the step portion.

In addition to the above, an aperture 57 is provided in the top plate 11 of the fixed part 3 for reception of a stirrup leather. The stirrup iron according to the invention is “reversible”, in other words it is designed to allow use of the stirrup iron on either the near side or the off side of the horse simply by rotating the stirrup iron through 180° about a vertical axis. The stirrup iron should be rotated in this way if used on the opposite side of the horse so that the moveable part opens and closes in a direction away from the horse to avoid pinching of the horse between the moveable part and the fixed part as the moveable part 5 comes into contact with the fixed part 3. It can be seen from the drawings that the free end of the top plate 11 and the free end of the step portion 15 are both dimensioned to engage the other of the free end of the top plate 11 and the free end of the step portion 15 to provide a secure and flush connection. Other constructions will be readily envisaged.

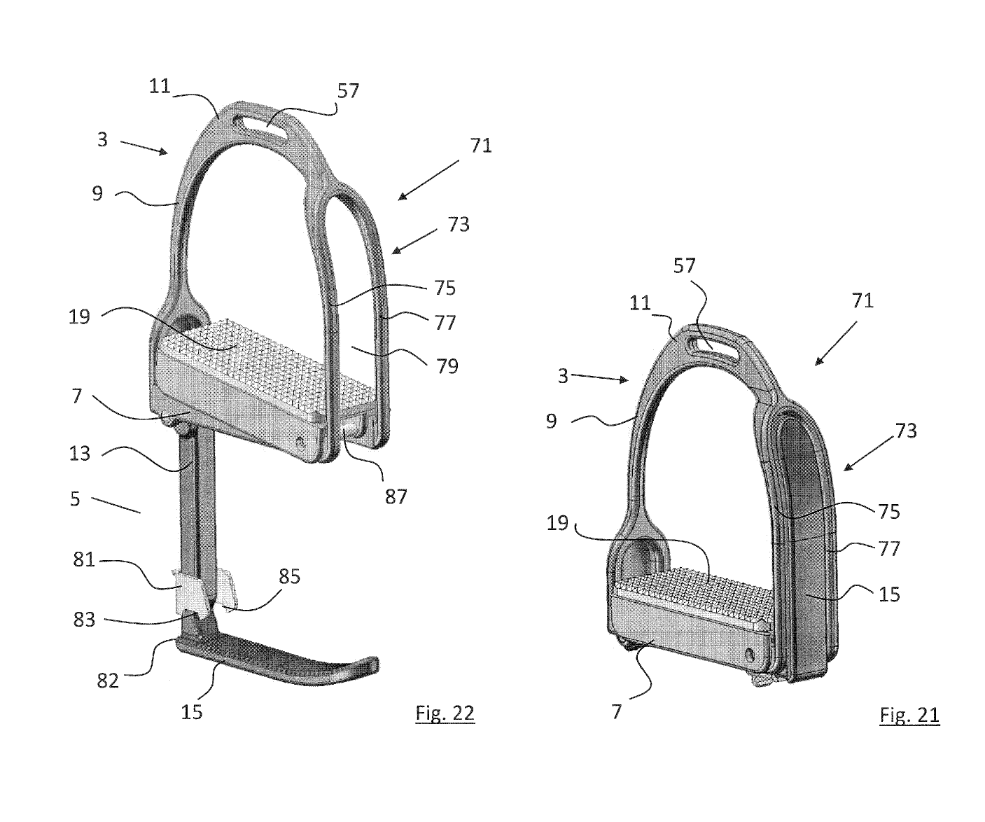

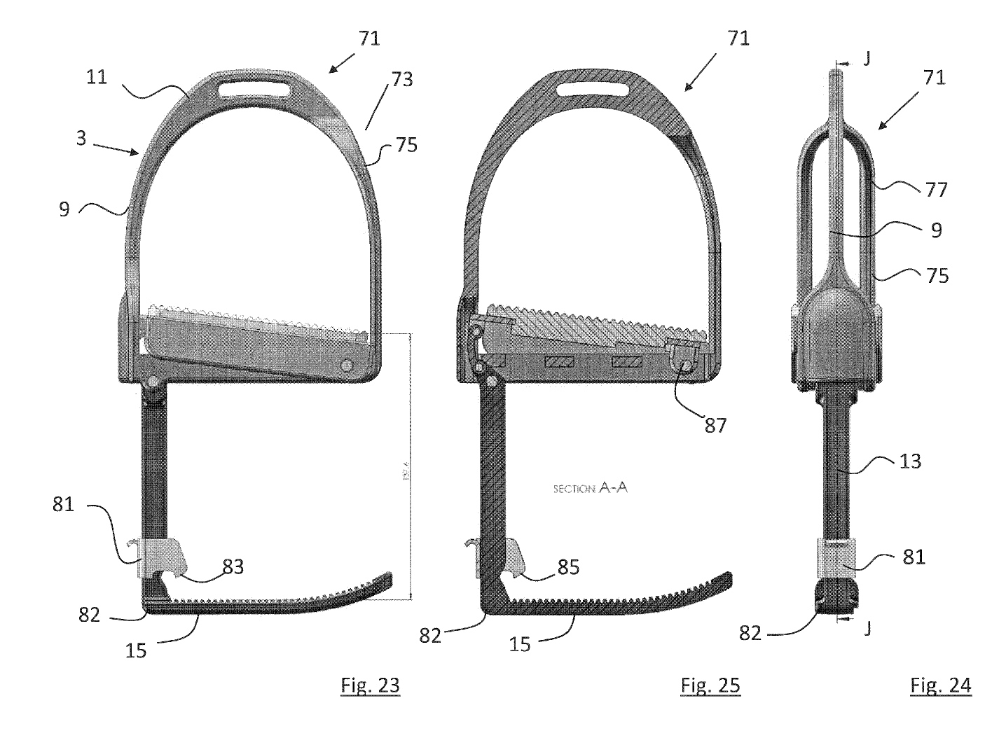

Referring to FIGS. 21 to 25 inclusive, there is shown a second alternative embodiment of stirrup iron, indicated generally by the reference numeral 71, in which like parts have been given the same reference numerals as before. The stirrup iron 71 differs from the previous embodiments of stirrup iron in that the fixed part 3, in addition to the base plate 7, the side upright 9 and the top plate 11, further comprises a second side upright 73. The second side upright 73 extends downwardly from the end of the top plate 11 remote from the side upright 9 to the end of the base plate 9 remote from the side upright 9 thereby forming a closed loop fixed part 3. The second side upright 73 comprises a bifurcated or wishbone shaped portion having a pair of arms 75, 77 that splay outwardly and downwardly from the top plate 7 towards the base plate 9. The pair of arms 75, 77 define a gap 79 therebetween for reception of the step portion 15 of the moveable part 5 when the moveable part is in the first position (as illustrated in FIG. 21).

Instead of the recessed locking mechanism described in relation to previous embodiments, the stirrup iron 71 comprises a slider 81, spring loaded towards the elbow 82 of the moveable portion, the elbow 82 being the intersection of the connector portion 13 and the step portion 15. The slider 81 has a pair of jaws 83, 85 for engagement of a locking bar 87. The locking bar 87 further operates as a pivot pin for the foot plate 19. It will be understood that as the moveable part 5 transitions from a second configuration as shown in FIG. 22 to a first configuration as shown in FIG. 21, the pair of jaws 83, 85 will come into engagement with the locking bar 87. Further movement of the moveable part 5 in that direction will cause the slider 81 to move along the connector portion 13 away from the elbow 82 and towards the end of the connector portion 13 mounted on the fixed part. As the pair of jaws 83, 85 pass the locking bar 87, the slider 81 will move back towards the elbow 82 with the jaws 83, 85 above the locking bar 87 thereby maintaining the moveable part 5 in position relative to the fixed part 3.

In order to release the moveable part and transition the moveable part from the first configuration as shown in FIG. 21 to the second configuration as shown in FIG. 22, the slider 81 is slid against the force of spring (not shown) in the direction along the connector portion 13 away from the elbow 82 until the jaws 83, 85 are free of the locking bar 87. Once the jaws 83, 85 are free of the locking bar 87, the moveable part 5 is pivoted downwardly about the pivot point of the connector portion 13 on the fixed part 3 to the second configuration as shown in FIG. 22 in which the step portion 15 may be used as a step.

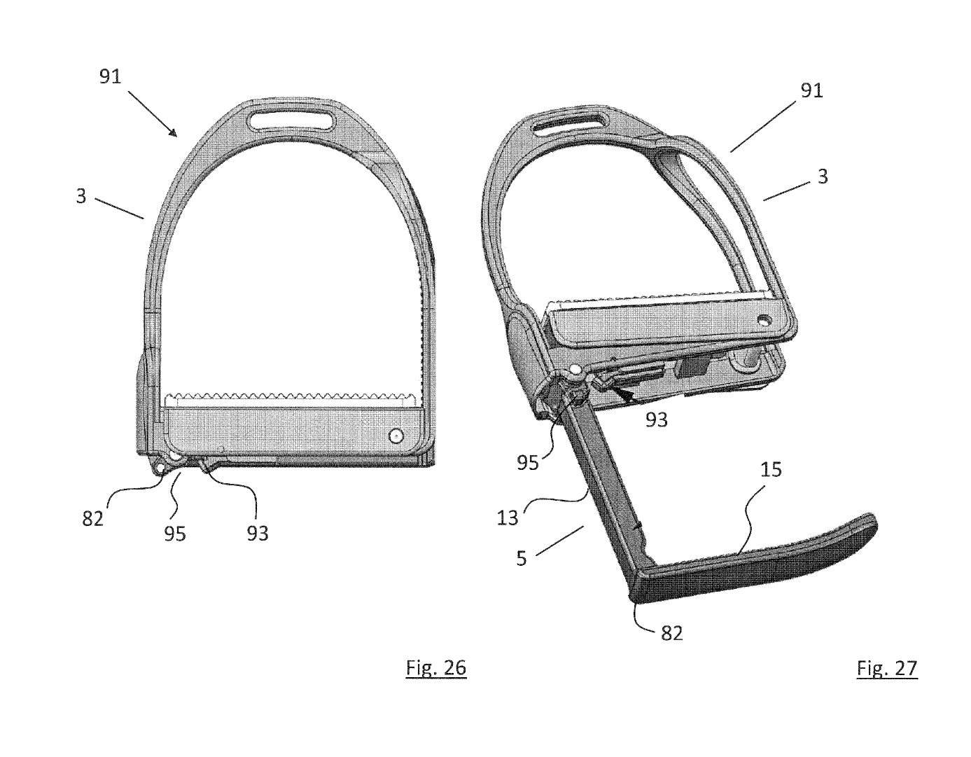

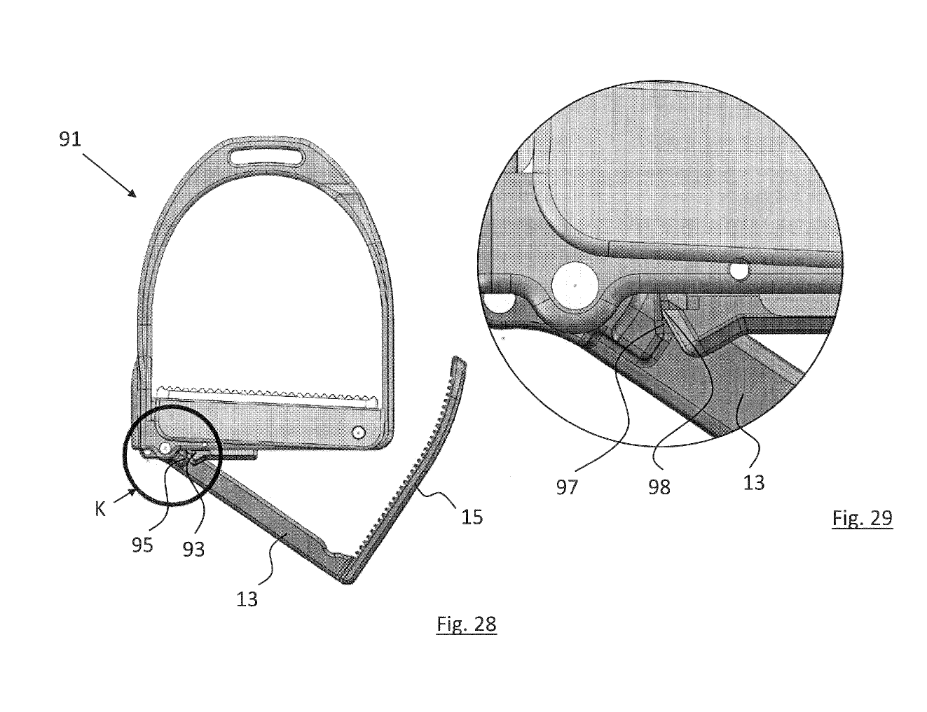

Referring to FIGS. 26 to 29 inclusive, there is shown a third alternative embodiment of stirrup iron, indicated generally by the reference numeral 91, in which like parts have been given the same reference numeral as before. The stirrup iron 91 is similar in construction to the stirrup iron described with reference to FIGS. 21 to 25 inclusive, with the exception that the locking mechanism to maintain the moveable part 5 in a fixed relationship with the fixed part 3 (i.e. in a first configuration) is different. Instead of providing a slider 81 with a pair of jaws 83, 85, the locking mechanism comprises a latch 93 mounted for reciprocal movement backwards and forwards along the fixed part 3 for releasable engagement of a lug 95 which in turn is mounted on the connector portion 13 of the moveable part 5. A spring (not shown) is provided to bias the latch in a direction away from the elbow 82 of the moveable part 5 and towards the point where the connector portion 13 is connected to the fixed part 3.

In use, as the moveable part is transitioned from a second operating position as shown in FIG. 27 to a first operating position as shown in FIG. 26, the latch 93 will come into contact with the topside 97 of the lug 95. The topside 97 of the lug 95 is sloped to promote the latch 93 to slide outwardly towards the elbow 82 as the moveable part 5 continues to travel upwards towards the first configuration/operating position. As the moveable part 5 continues to travel upwards about the pivot point of the connector portion 13 on the fixed part 3, the tip 98 of the latch will pass over the sloped surface of the lug to a point where the tip is below the lug 95. At this point, the spring force acting on the latch 93 will cause the tip 98 to pass underneath the lug 95. In this position, the latch will act against the lug 95 in such a way that is will prevent downward movement of the moveable part 5 relative the fixed part 3 from a first operating position as shown in FIG. 26 to the second operating position as shown in FIG. 27.

In order to release the moveable part 5 and allow downward movement of the moveable part 5 relative the fixed part 3, from a first operating position as shown in FIG. 26 to the second operating position as shown in FIG. 27, the latch 93 is slid against the spring (not shown) in the direction towards the elbow 82 until the tip 98 of the latch 93 is free of the underside of the lug 95 at which point it will be possible to pivot the moveable part 5 downwards from the first operating position as shown in FIG. 26 to the second operating position as shown in FIG. 27.

In this specification the terms “comprise, comprises, comprised and comprising” and the terms “include, includes, included and including” are all deemed totally interchangeable and should be afforded the widest possible interpretation.

The invention is in no way limited to the embodiments hereinbefore described but may be varied in both construction and detail within the scope of the claims.

1. A stirrup iron comprising a two part construction including a first, fixed part, and a second, moveable part, moveable relative to the fixed part;
the fixed part comprising a body having a base plate, a side upright connected at one end of the base plate and extending upwardly therefrom, and a top plate connected at one of its ends to the side upright and extending outwardly therefrom above and spaced apart from the base plate;
the moveable part comprising a substantially L-shaped arm having a connector portion pivotally mounted to the fixed part at one end thereof, and a step portion extending substantially orthogonal to the connector portion, the moveable part being pivotable to and from a first operating position in which the connector portion lies adjacent to and substantially in-line with the base plate and the step portion extends upwardly from the free end of the base plate to the free end of the top portion thereby foaming a closed loop stirrup, and a second operating position in which the connector portion extends downwardly from and substantially orthogonal to the base plate and the step portion extends outwardly from the connector portion below and spaced apart from the base plate thereby forming a foot-step;
and in which the stirrup iron comprises:
a releasable locking mechanism operable to maintain the moveable part in the first operating position;
a foot plate mounted on the fixed part; and
a cam mechanism connecting the foot plate to the moveable part so that depression of the foot plate will cause the cam mechanism to act on the moveable part urging it from the second operating position towards the first operating position.

2. A stirrup iron as claimed in claim 1 in which the cam mechanism comprises a single connector link arm pivotably mounted at one end to the foot plate and pivotally mounted at its other end to the connector arm.

3. A stirrup iron as claimed in claim 1 in which the cam mechanism comprises a pair of spaced-apart connector link arms pivotably mounted at one end to the foot plate and pivotally mounted at the other end to the connector arm.

4. A stirrup iron as claimed in claim 1 in which the foot plate is provided with a non-slip cover.

5. A stirrup iron as claimed in claim 4 in which the non-slip cover is releasably detachable from the foot plate.

6. A stirrup iron as claimed in claim 1 in which one side of the step portion that is intended for engagement of a riders boot is provided with a non-slip surface.

7. A stirrup iron as claimed in claim 6 in which the non-slip surface is provided by way of a serrated surface.

8. A stirrup iron as claimed in claim 1 in which the releasable locking mechanism is provided with a catch mechanism which is spring loaded into a locking configuration.

9. A stirrup iron as claimed in claim 1 in which the catch mechanism is provided with a release button that is recessed into the two part construction to avoid inadvertent release of the releasable locking mechanism.

10. A stirrup iron as claimed in claim 1 in which the free end of the top plate and the free end of the step portion are both dimensioned for complementary mating with the other of the free end of the step portion and the free end of the top plate.

11. A stirrup iron as claimed in claim 1 in which the top plate is provided with an aperture for reception of a stirrup leather.

12. (canceled)

13. A stirrup iron as claimed in claim 2 in which the cam mechanism comprises a pair of spaced-apart connector link arms pivotably mounted at one end to the foot plate and pivotally mounted at the other end to the connector arm.

14. A stirrup iron as claimed in claim 2 in which the foot plate is provided with a non-slip cover.

15. A stirrup iron as claimed in claim 3 in which the foot plate is provided with a non-slip cover.

16. A stirrup iron as claimed in claim 2 in which one side of the step portion that is intended for engagement of a riders boot is provided with a non-slip surface.

17. A stirrup iron as claimed in claim 3 in which one side of the step portion that is intended for engagement of a riders boot is provided with a non-slip surface.

18. A stirrup iron as claimed in claim 4 in which one side of the step portion that is intended for engagement of a riders boot is provided with a non-slip surface.

19. A stirrup iron as claimed in claim 5 in which one side of the step portion that is intended for engagement of a riders boot is provided with a non-slip surface.

20. A stirrup iron as claimed in claim 2 in which the releasable locking mechanism is provided with a catch mechanism which is spring loaded into a locking configuration.

21. A stirrup iron as claimed in claim 3 in which the releasable locking mechanism is provided with a catch mechanism which is spring loaded into a locking configuration.
